(19) United States
(12) Patent Application Publication
(10) Pub. No.: US 2010/0066941 A1
(43) Pub. Date: Mar. 18, 2010

(54) HYBRID LIGHTING PANEL AND LCD SYSTEM

(75) Inventors: Dung T. Duong, Cedar Park, TX (US); Hyunchul Ko, Austin, TX (US)

Correspondence Address: SPRINKLE IP LAW GROUP, 1301 W. 25TH STREET, SUITE 408, AUSTIN, TX, 78705, US

(73) Assignee: Illumitex, Inc., Austin, TX (US)

(21) Appl. No.: 12/559,363

(22) Filed: Sep. 14, 2009

Related U.S. Application Data
(60) Provisional application No. 61/097,423, filed on Sep. 16, 2008.
(60) Provisional application No. 61/229,642, filed on Jul. 29, 2009.

(51) Int. Cl. G02F 1/1335; F21V 7/04

(52) U.S. Cl. 349/61; 362/616; 362/611; 362/612; 362/84; 362/613

(57) ABSTRACT

A hybrid lighting panel may have a first light guide and a second light guide proximate to the first light guide. The first light guide may receive light from a light source such as an LED array. The first light guide is configured to distribute the light along the length of the first light guide and distribute the light out a first light guide face such that light exiting the first light guide face enters the second light guide. The second light guide is configured to distribute light across the width of the second light guide and distribute light out a second light guide face. Hybrid lighting panels may be used individually or assembled as a system to provide light. A controller can control lighting to each panel to allow for individual dimming. One or more panels may be used to backlight an LCD layer.

### RELATED APPLICATIONS

This application claims priority to U.S. Provisional Patent Application Ser. No. 61/097,423 by inventor Dung T. Duong, entitled “Hybrid LCD System and Method” filed on Sep. 16, 2008 and U.S. Provisional Patent Application Ser. No. 61/229,642 by inventors Dung T. Duong and Hyunchul Ko, entitled “Orthogonally Separable Light Bar, filed Jul. 29, 2009, the entire contents of which are hereby expressly incorporated by reference for all purposes.

### TECHNICAL FIELD

Embodiments described herein provide systems and methods for lighting. In particular, embodiments described herein provide systems and methods for lighting an LCD panel that include hybrid systems for lighting the LCD panel.

### BACKGROUND

LCDs include a liquid crystal layer that either blocks light or allows light to pass based on whether or not electricity is applied to the liquid crystal layer. By segmenting the layer into millions of small regions, light can be selectively blocked or allowed to pass to create an image. Light is typically provided to the liquid crystal layer through edge lighting or direct backlighting. In a directly backlit system, LEDs are arranged behind the liquid crystal layer and project light on the liquid crystal layer (potentially through one or more filter layers). Direct backlighting allows for local dimming of the light source and can thus achieve high contrast ratios. However, directly backlit LCDs are generally thicker, require a larger number LEDs and cost more. These shortcomings have limited directly backlit LCDs to larger screen displays and televisions (e.g., 32 inches and up).

Edge lighting is often used for smaller displays, particularly cell phones, computer monitors and smaller televisions. In an edge-lit system, a smaller number of LEDs are aligned along an edge of a light guide. The light guide provides light to a particular area of the liquid crystal layer. Edge-lighting requires less thickness than directly backlighting, lower cost and a lower number of LEDs. However, edge-lighting still requires a sufficient number of LEDs so that light is projected through the entire length of an edge. Providing local dimming in edge-lit systems can be difficult.

### BRIEF SUMMARY

Embodiments described herein provide a hybrid light guide. Embodiments of a hybrid lighting panel can include a first light guide and a second light guide. The first light guide can have an exit face that abuts or is optically coupled to the entrance face of a second light guide. The first light guide is configured to distribute the light out of a first light guide exit face along a first direction. The second light guide is configured to distribute light across a second direction. According to one embodiment, the second light guide is configured to distribute light out a second light guide exit face orthogonal to the first light guide exit face. The first light guide may have a taper configured to increase the uniformity of distribution of light out the first light guide exit face. The hybrid lighting panel may include one or more light sources that provide light into the first light guide. The light source can be an LED or an LED array comprising LEDs of a single color or LEDs of multiple colors. The light guides can include a phosphor layer to down convert light. Embodiments of a hybrid lighting panel system may include a plurality of hybrid lighting panels. The plurality of hybrid lighting panels are proximate each other and can be spaced so that the exitance of each light panel overlap.

According to one embodiment, a hybrid panel can be used to light an LCD layer for an LCD display or provide light to other devices. An array of panels can be arranged behind a liquid crystal layer to backlight the liquid crystal layer in controllable segments to allow for independent dimming of each segment. The panels can be modular so that any number of panels can be fit together to backlight a display. Consequently, manufacturers can arrange panels to create small displays or larger displays.

These, and other, aspects of the disclosure will be better appreciated and understood when considered in conjunction with the following description and the accompanying drawings. The following description, while indicating various embodiments of the disclosure and numerous specific details thereof, is given by way of illustration and not of limitation. Many substitutions, modifications, additions or rearrangements may be made within the scope of the disclosure, and the disclosure includes all such substitutions, modifications, additions or rearrangements.

### BRIEF DESCRIPTION OF THE DRAWINGS

A more complete understanding of the present disclosure and the advantages thereof may be acquired by referring to the following description, taken in conjunction with the accompanying drawings in which like reference numbers indicate like features and wherein:

FIG. 1 depicts a side view of one embodiment of an LCD structure;

FIGS. 2 and 3 depict perspective views of one embodiment of a hybrid lighting panel;

FIG. 4 depicts a perspective view of one embodiment of a hybrid lighting panel;

FIG. 5 depicts a side view of one embodiment of a hybrid lighting panel;

FIG. 6 depicts a close up view of a portion of one embodiment of a hybrid lighting panel;

FIG. 7 depicts a perspective view of one embodiment of a hybrid lighting panel;

FIG. 8 depicts a perspective view of one embodiment of a light guide for use in a hybrid lighting panel;

FIG. 9 depicts an end view of one embodiment of a light guide for use in a hybrid lighting panel;

FIG. 10 depicts an end view of one embodiment of a light guide for use in a hybrid lighting panel;

FIG. 11 depicts an end view of one embodiment of a light guide having pump sources on both ends for use in a hybrid lighting panel;

FIG. 12 depicts an end view of one embodiment of a light guide having a remote pump source for use in a hybrid lighting panel;

FIG. 13 depicts an end view of one embodiment of a light guide having a pattern of spatially separated phosphors for use in a hybrid lighting panel;

FIG. 14 depicts a perspective view of one embodiment of a light guide having a phosphor layer for use in a hybrid lighting panel;

FIG. 15 depicts a perspective view of one embodiment of a hybrid lighting panel formed from multiple panels;

FIG. 16 depicts a close up side view of a portion of a hybrid lighting system, showing a bottom edge of a first hybrid lighting panel and a top edge of an adjacent hybrid lighting panel;

FIG. 17 depicts a close up end view of a portion of a hybrid lighting system, showing a side edge of a first hybrid lighting panel and a side edge of an adjacent hybrid lighting panel; and

FIG. 18 depicts a diagrammatic representation of a light guide having reflectors.

### DETAILED DESCRIPTION

Preferred embodiments of the present invention are illustrated in the FIGURES, like numerals being used to refer to like and corresponding parts of the various drawings.

As used herein, the terms “comprises,” “comprising,” “includes,” “including,” “has,” “having” or any other variation thereof, are intended to cover a non-exclusive inclusion. For example, a process, process, article, or apparatus that comprises a list of elements is not necessarily limited only those elements but may include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example”, “for instance”, “e.g.”, “in one embodiment”.

Embodiments described herein provide a hybrid lighting panel and system. The hybrid lighting panel can be used for lighting in any number of devices including, but not limited to, LCD displays.

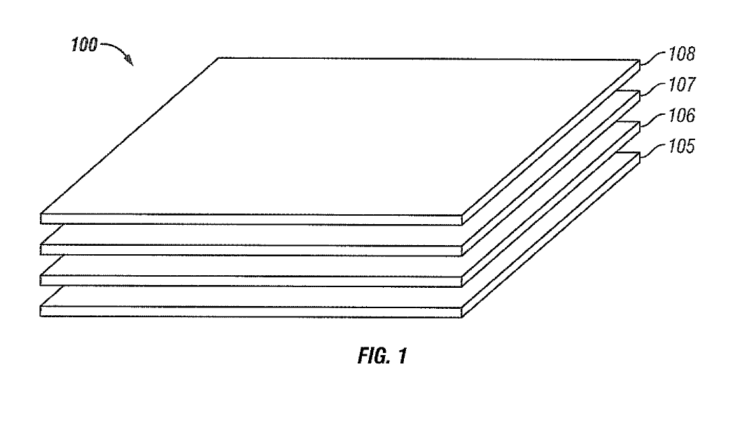

FIG. 1 depicts a perspective view of one embodiment of LCD structure 100, showing light panel 105, filter panel 106, dispersion panel 107, and LCD panel 108. LCD structure 100 may include more or fewer layers. Light panel 105 can provide light through any number of layers to LCD panel 108. LCD panel 108 can be controlled to allow or not allow light through various portions of the panel 108 to create an image. LCD structure 100 is provided by way of example, and light panel 105 can be used to light any LCD structure known or developed in the art.

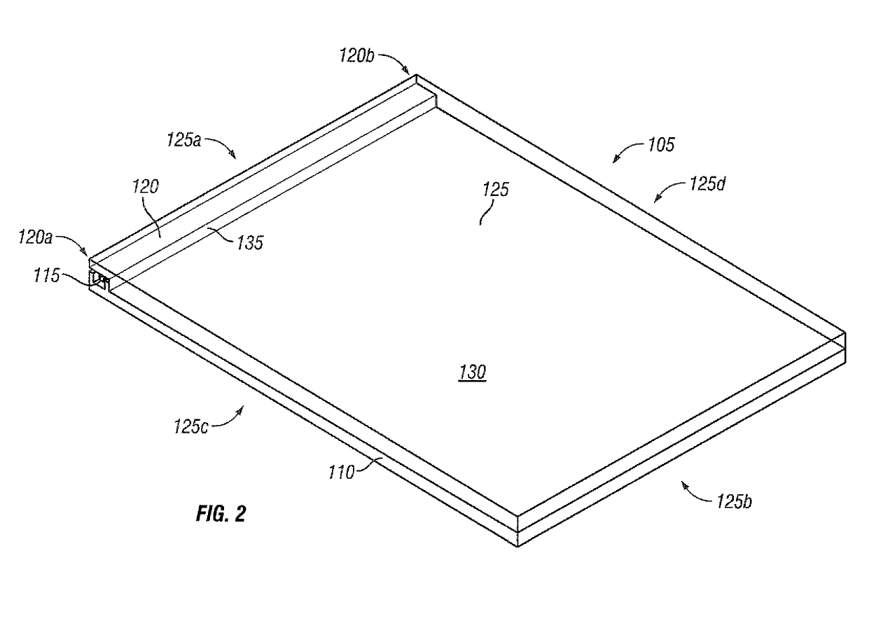

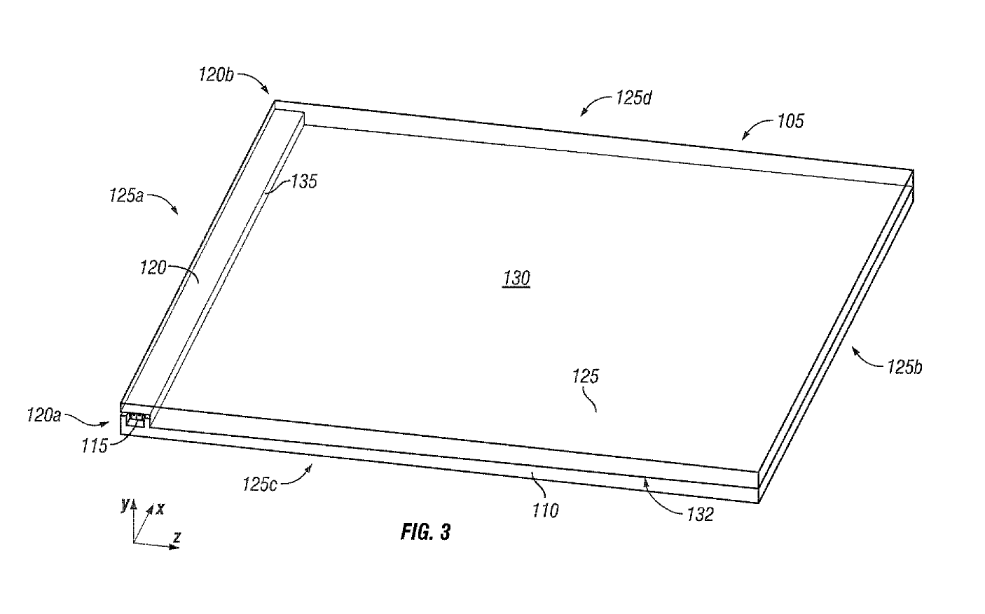

FIGS. 2 and 3 depict perspective views of an embodiment of a hybrid lighting panel 105. Hybrid lighting panel 105 can include first light guide 120 and a second light guide 125. Second light guide 125 is in contact with or otherwise optically coupled to an exit face 135 of first light guide 120 so that light can exit light guide 120 into light guide 125. Light guide 120 can be configured to distribute light along exit face 135 in a desired profile. Light entering first light guide 120 may be distributed to second light guide 125 by exiting a first face 135 directly, may be distributed by internal reflection along light guide 120 to some other point and then exit the face 135 or be otherwise distributed to exit face 135. Light guides 120 and 125 can be made of any suitable material to transfer light including a clear acrylic, Zeonor, Zeonex, polycarbonate, plastic, extruded plastic, glass, polyacrylate or other material that will allow light propagate using total internal reflection.

According to one embodiment, first light guide 120 and second light guide 125 can be shaped so that light is distributed out face 130 of second light guide 125 in a substantially uniform manner. One or both of first light guide 120 and second light guide 125 can be tapered so that light exits in a substantially uniform manner. The surface roughness of first light guide 120 or second light guide 125 can be varied, according to one embodiment, to help control the uniformity of light exiting first light guide 120. First light guide 120 can have any desired shape including, square, rectangular, or other shape.

In some embodiments, hybrid lighting panel 105 may be mounted to backing layer 110, such as a circuit board, diffuser or other layer or combination of layers. First light guide 120 and/or second light guide 125 can be coupled to layer 110 using a chassis or other mechanism that will allow total internal reflection to occur in first light guide 120 and second light guide 125.

Light panel 105 can be illuminated by light source 115. Light source 115 may include one or more LEDs of a single color or an array of multicolor LEDs or other lights. In a preferred embodiment, light source 115 can be an LED array having any number of LEDs. In some embodiments, light source 115 includes red, green and blue LEDs that can be operated together to create a number of colors. By way of example, but not limitation, light source 115 can use two green, one blue and two red LEDs. In such an embodiment, each panel 105 uses 5 LEDs. However, other embodiments can use more or fewer LEDs as needed or desired.

According to one embodiment, the LEDs can be shaped substrate LEDs or LEDs using a shaped optical device as produced by Illumitex, Inc. of Austin, Tex. According to one embodiment, the LEDs can be shaped substrate LEDs as described in U.S. patent application Ser. No. 11/906,194, “LED System and Method,” which is hereby fully incorporated by reference herein.

Light from light source 115 enters first light guide 120 from first end 120a in the direction of second end 120b. First light guide 120 is shaped to distribute the light from first end 120a to second end 120b (i.e., to distribute light along the direction of first edge 125a) such that light exits first light guide 120 through face 135 into second light guide 125. Second light guide 125 is shaped to distribute the light entering from face 135 to edge 125a and edge 125b. Through the combination of distribution by light guide 120 and light guide 125, light can be distributed from edge 125a-125b and 125c-125d (i.e., across the area of panel 105) such that the light exits panel 125 through face 130. The first and second light guides can be configured to distribute light so that light exits exit face 130 with a desired profile including, but not limited to, a substantially uniform profile.

According to an embodiment, first light guide exit face 135 projects on a first plane (e.g., the x-y plane) and second light guide exit face 130 projects on a second plane (e.g., the x-z plane) that is perpendicular to the first plane and parallel to the entrance face of a liquid crystal layer. While the first plane may be perpendicular to the second plane, exit face 130 may not be perpendicular to exit face 135 due to tapering. In the embodiment shown, light enters light guide 120 perpendicular to a third plane (e.g., the y-z plane) and perpendicular to the first plane and the second plane. However, light may enter at other angles.

A diffuser layer may be on either face 130 or bottom surface 132 of second light guide 125. The diffuser layer can be a diffuser film (such as a diffuser film made by 3M, Inc. of St. Paul, Minn. In another embodiment, the face 130 or surface 132 of second light guide 125 can be roughened to create a diffuser. Embodiments can employ both a roughened light guide surface and a diffuser film. Other embodiments can comprise other diffuser mechanisms. Hybrid lighting panel 105 can also include other backing layers or layers over exit face 130.

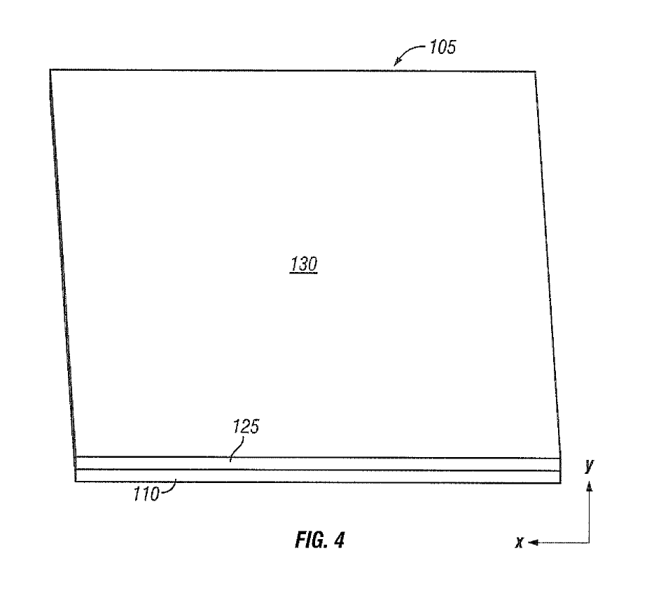

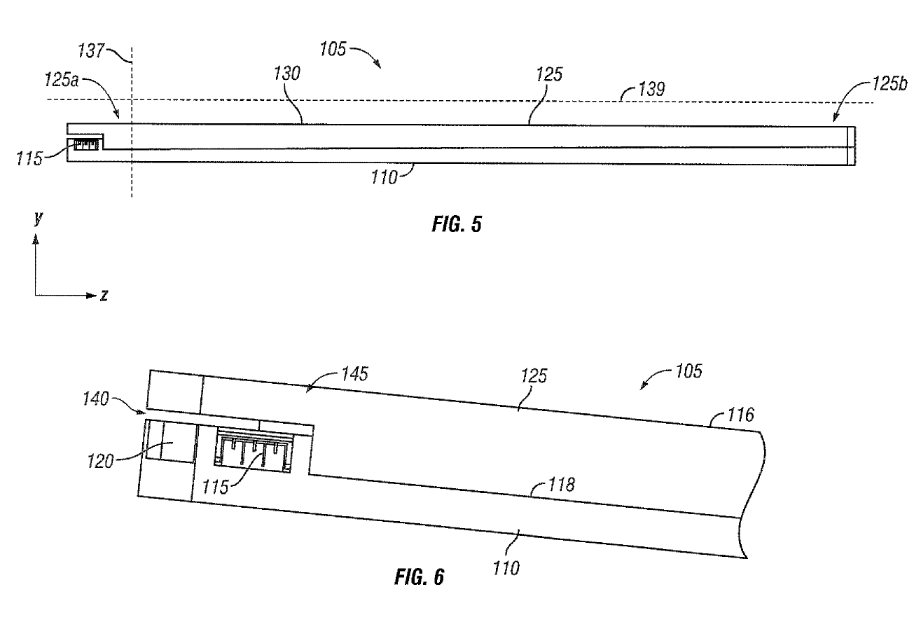

FIG. 4 is a diagrammatic representation of a perspective view of one embodiment of panel 105 showing layer 110, light guide 125 and face 130, and FIG. 5 is a diagrammatic representation of a side view of one embodiment of panel 105 illustrating layer 110, light guide 125 and light source 115. FIG. 5 also illustrates the edge of the first plane 137 and the second plane 139 onto which the face 135 (shown in FIG. 3) and face 130 project light. Light guide 125 may be tapered (i.e., light guide 125 may be thicker closer to a first edge 125a than at second edge 125b) for improved light distribution. In some embodiments, the surface roughness of light guide 125 may be higher at second edge 125b than at first edge 125a to improve light distribution across light guide 125.

FIG. 6 is a diagrammatic representation showing a portion of one embodiment of hybrid lighting panel 105 including light guide 125, light guide 120, layer 110 and light source 115. As shown in FIG. 6, light guide 125 may be separated from light guide 120 by an air gap 140 so that light guide 125 contacts light guide 120 only along a single face. This prevents light from entering light guide 125 through portion 145 that overhangs light guide 120. Additionally, light guide 120 may be recessed slightly so that light guide 120 does not contact the end of an adjacent light guide 125 of another panel 105, as discussed below. The air gaps promote internal reflection in light guide 120 to reduce light leakage out faces other than face 135. Overhang portion 145 of light guide 125 also overhangs Light source 115. Light emitted out overhang portion 145 prevents Light source 115 or light guide 120 from appearing as a small dead spot. In other embodiments, light guide 125 does not overhang light guide 120. In these cases, light guide 120 can be the same thickness as light guide 125 at face 135. Additionally, light guide 120 can allow some light to escape the top face so that light guide 120 does not appear as a dead spot. The exitance of such light can be controlled so that light source 115 also does not appear as a dead spot.

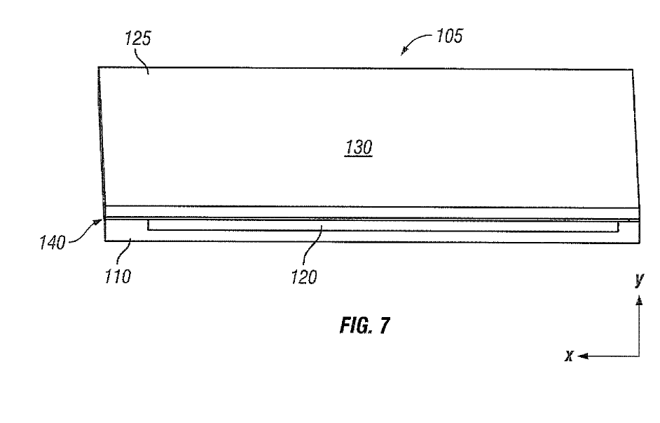

FIG. 7 depicts a perspective view of one embodiment of panel 105 illustrating layer 110, first light guide 120, second light guide 125, face 130 and air gap 140. In the embodiment illustrated, light guide 120 does not extend the entire length of light guide 125 along the x-axis.

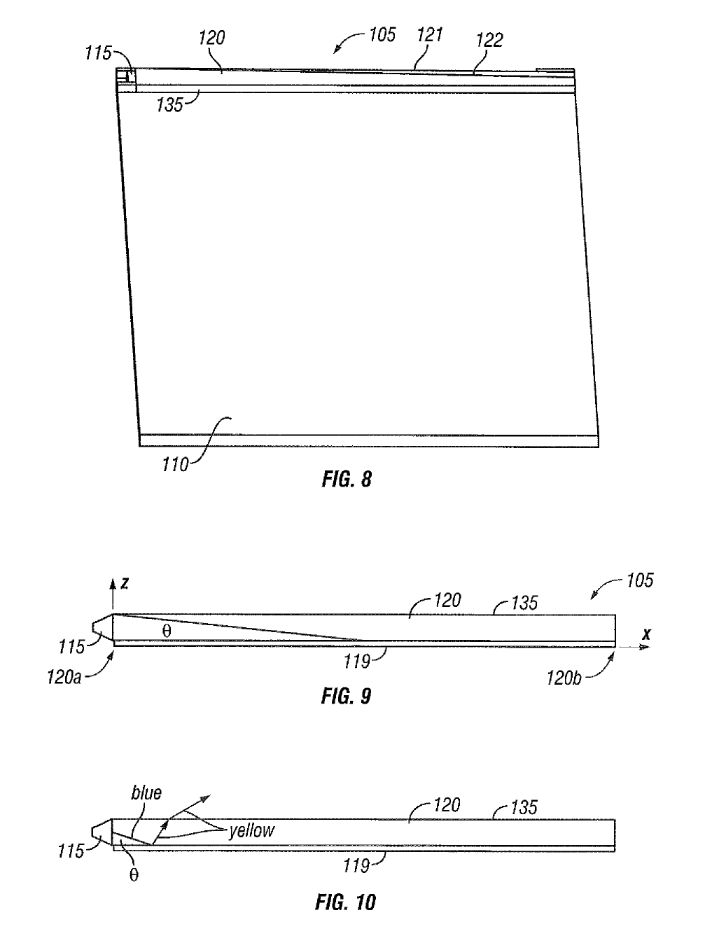

FIG. 8 depicts a top view of a portion of one embodiment of panel 105 in which second light guide 125 is removed to show light source 115, layer 110, first light guide 120 and face 135. As depicted in FIG. 8, first light guide 120 may be straight as depicted by line 121 or taper as depicted by line 122. Taper 122 can be straight, curved or have another desired shape. In embodiments having a taper, light entering first light guide 120 from light source 115 typically contacts the faces of first light guide 120 at a steep angle near light source 115 and at a shallow angle farther away from light source 115. By tapering first light guide 120 at some angle, the amount of light contacting face 135 away from light source 115 may be increased to increase the amount of light exiting first light guide 120 away from light source 115. Consequently, the taper can be used to make the light distribution more uniform.

Light guide 120 can include a phosphor layer to down convert light entering light guide 120. According to one embodiment, the phosphors are orthogonally separate from the light source 115. To achieve orthogonal separation, phosphors are disposed along one or more surfaces orthogonal to the entrance face of light guide 120.

FIG. 9 depicts a partial top view of hybrid lighting panel 105, illustrating one embodiment of first light guide 120 having phosphor layer 119 opposite face 135. The concentration of phosphor in phosphor layer 119 may vary along the length of first light guide 120. In some embodiments, the concentration of phosphor is greater at end 120b than 120a (i.e., the concentration is increased at points farther away from light 115.

The phosphors can include any suitable phosphors for light system applications including, but not limited to, phosphor particles. The phosphors can be applied according to any technique known or developed in the art including, but not limited to, applying the phosphors in a layer of a silicone binding material. The phosphors can be disposed on one or more surfaces of first light guide 120 orthogonal to the entrance face through which light enters first light guide 120. The size, density, thickness, pattern, emission wavelength or other property of the particle layer can vary along the length of first light guide 120 to control the uniformity or color along first light guide 120. Multiple phosphors may also be used to control the color of emitted light. While, in the above embodiment, phosphor is shown on the side opposite face 135, phosphor can be disposed on any of the sides orthogonal to the face through which light enters first light guide 120. FIG. 10 depicts a side view of one embodiment of hybrid lighting system 105 showing first light guide 120 and light source 115 with blue LEDs and phosphor layer 119. When light is incident on phosphor layer 119, phosphor layer 119 down converts the light and emits the down converted light normal to the angle of the original light. Using the example of FIG. 10, when blue light is incident on the phosphor, the phosphor will down convert the blue light to yellow light. The phosphor will emit light in a lambertian pattern. Consequently, the yellow light is likely to exit face 135 of first light guide 120 and enter light guide 125.

Thus, light can escape light guide 120 out exit face 135 via multiple mechanisms. First, the yellow light in the escape cone of light guide 120 will escape through exit face 135. Second, the light that is not within the escape cone will reflect back towards phosphor layer 119 and can probabilistically scatter into the escape cone. This can repeat until the light is either absorbed (e.g., by a reflector or elsewhere) or light escapes face 135. Light that escapes out a side of light guide 120 is directed back into light guide 120 using a reflector. Light that is reflected back into light guide 120 can either escape exit face 135 or bounce around until it is absorbed.

As can be seen from FIGS. 9 and 10, the phosphors may be arranged along a plane orthogonal to the entrance face through which light enters light guide 120 from the pump source (e.g., light source 115). Consequently, only the portion of phosphor under the line at angle θ will emit light that can potentially reenter light source 115. As the length of first light guide 120 or phosphor layer 119 increases, the smaller the percentage of phosphor that will emit light that can reenter light source 115.

Light source 115 is orthogonal to the phosphors, therefore, the emissions from the phosphors do not or are less likely to directly illuminate light source 115 compared to previous solutions for using phosphors with LEDs. Depending on the length scales, very little of the phosphors may see light source 115. In other words, light source 115 only occupies a small angular subtense as viewed by the phosphor. Therefore the light source's absorption or reflectivity is not a large factor in overall phosphor package efficiency. While light source 115 has a relatively high exitance, the phosphor may have a relatively low irradiance. This implies that per unit area, the flux density of pump energy on the phosphor is relatively small, thus leading to low thermal rise due to Stoke Shifts. The phosphors can be independently cooled over a much larger surface area. When using multiple phosphor types, phosphor self-absorption may be minimized. Consequently, phosphors can be used to down covert light without efficiency losses associated with previous solutions for using phosphors with LEDs.

Nano phosphor particles/quantum dots (“QD”) may also be used to down convert light. One major drawback of nanoparticles/QDs in existing lighting systems binder material that holds them together degrades with temperature. Such is not the case of embodiments of first light guide 120. Stoke shift heating is minimized because the irradiance of light source 115 is spread over a much larger area. Also, since the nanoparticles/QDs are positioned away from the source and can be independently cooled, first light guide 120 allows for the effective use of nanoparticles/QDs.

According to one embodiment, a reflector (diffuse or specular), can surround first light guide 120 in-order to divert all the down-converted and scattered blue (or other color) radiation out surface 135. In one embodiment, the reflector can touch first light guide 120, but not make intimate contact with first light guide 120. Touching is lightly set without optical interface. Inherently there is a very small air gap. Pressing down or using liquid bonding, on the other hand, creates intimate contact and reduces or eliminates the inherent air gap. Thus, according to one embodiment, the reflector contacts first light guide 120 in some limited places, but the reflector is not pressed against first light guide 120 or coupled to first light guide 120 with a liquid, adhesive or compliant material. Consequently, an air gap, which is potentially very thin, exists between much of the reflector and first light guide 120. In other embodiments, the gap may be filled with another material besides air. The material can have a lower index of refraction than first light guide 120 to preserve total internal reflection. A person of ordinary skill in the art can determine the index difference/ratio necessary to preserve Total Internal Reflection (TIR).

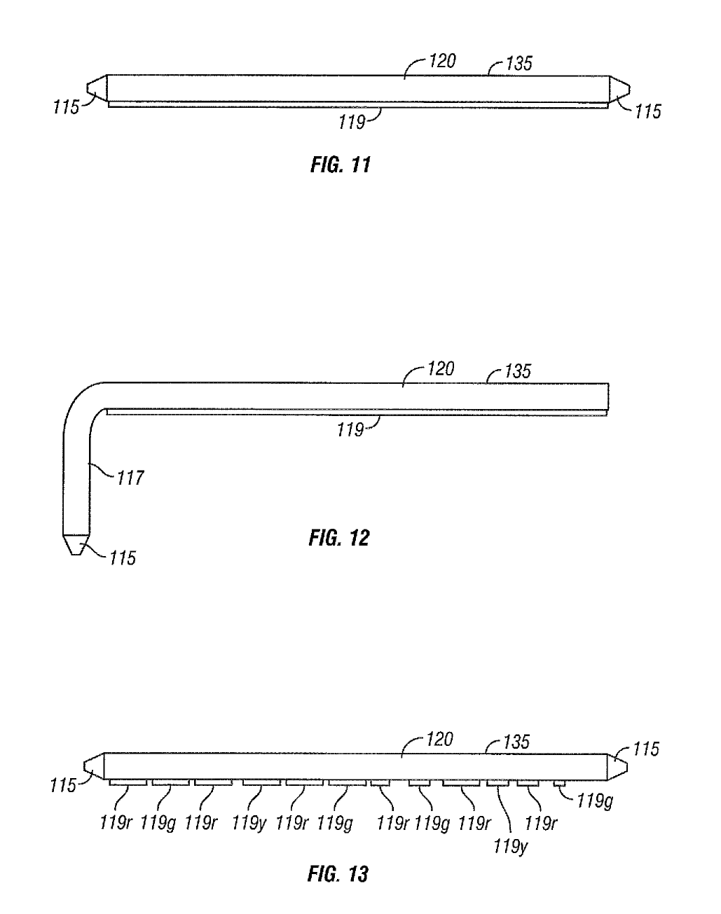

Hybrid lighting system 105 may also take advantage of multiple and/or remote lighting sources. FIG. 11 depicts a side view of a portion of one embodiment of hybrid lighting system 105 in which light source 115 is located on either end of first light guide 120. In some cases, light source 115 does not have to be directly inline with first light guide 120 but can be optically coupled to first light guide 120 using fiber optics, reflectors or other optical coupling mechanisms. FIG. 12 depicts a side view of a portion of one embodiment of hybrid lighting system 105 in which Light source 115 is located remote from first light guide 120 and light propagates from light source 115 through fiber optic cable 117 to first light guide 120. In one embodiment, fiber optics or other optical coupling mechanisms can direct light from a centralized light source to multiple panels.

Furthermore, light guide 120 or light guide 125 allows for the use of multiple phosphors for color control. According to one embodiment, the phosphors can be spatially separated to minimize interaction between phosphors and optimize color temperature and uniformity. FIG. 13 depicts a side view of a portion of one embodiment of hybrid lighting system 105 in which phosphor layer 119 comprises spatially separated phosphors. Phosphors can emit light in all directions. The light emitting down toward the reflector, if present, mostly only sees itself; phosphors do not generally absorb the wavelengths they emit. The light that emits up and is within the critical angle of the light guide will exit out face 135. The part that emits toward face 135 and is not within the critical angle will hit the side reflectors (diffuse) and generally scatter toward face 135. Only the portion that scatters back toward the phosphor region will have a chance to interact with the other color phosphors. As depicted in FIG. 13, phosphor layer 119 may comprise phosphors with selected colors, such as red phosphors 119r, green phosphors 119g and yellow phosphors 119y. Layer 119 may include other phosphor colors as well. The various phosphors can be separated by gaps to reduce interaction.

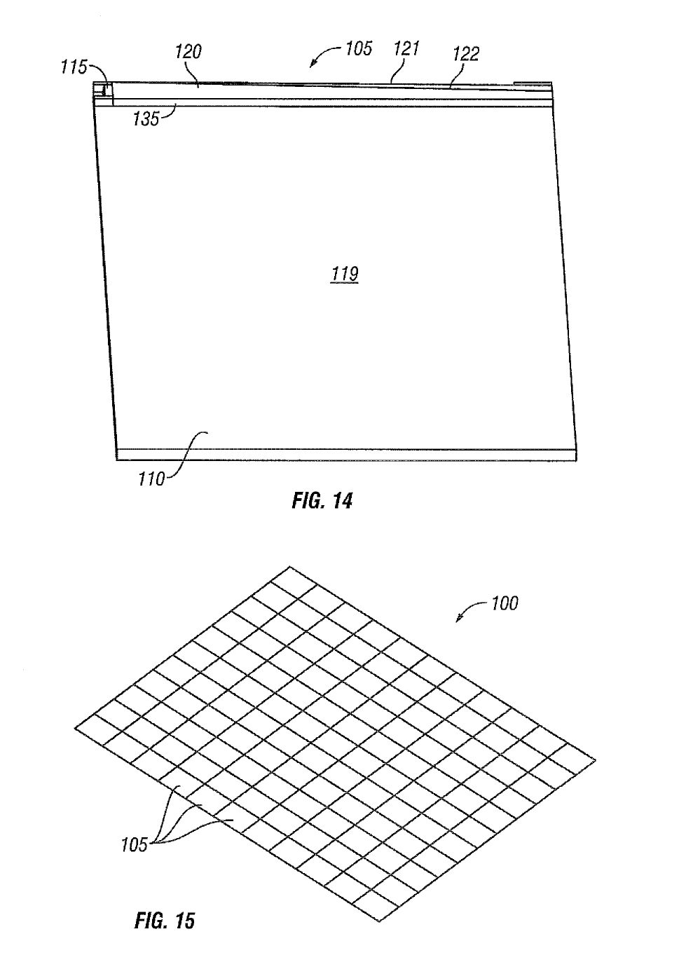

Hybrid lighting system 105 may include phosphor layer 119 on second light guide 125. FIG. 14 depicts a perspective view of a portion of one embodiment of hybrid lighting system 105 in which phosphor layer 119 is disposed on layer 110. When light guide 125 is added, phosphor layer 119 will be positioned to down convert light in light guide 125. Phosphor layers may be applied to other portions of light guide 120 or 125 as needed or desired.

The previous examples address various embodiments of single hybrid lighting panels 105. To make a large display, a system of hybrid lighting panels 105 may be assembled. FIG. 15 depicts a perspective of hybrid lighting system 200 that may be made of an array of 169 panels 105 (i.e., 13×13). The amount of light provided to multiple hybrid lighting panels 105 may be controlled by a controller. The controller can control individual panels 105 or multiple panels 105. Advantageously, each panel 105 in system 200 may be locally dimmed to a resolution of 1/169^{th} the display area. According to one embodiment, the number of LEDs can be comparable to an edge lit system helping keep the overall cost of hybrid lighting system 200 comparably low. Thus, embodiments described herein can lead to a reduction in the number of LEDs compared to traditional directly back lit systems while allowing for local contrast control using multiple panels.

A concern with having a lighting system formed with multiple panels is the light distribution between panels. FIGS. 16 and 17 depict close-up end and side views of one embodiment of hybrid lighting system 200, showing gaps 150 and the exitance of light from second light guides 125. In particular, FIG. 16 depicts a close-up end view of one embodiment of hybrid lighting system 200 showing gap 150 between third edge 125c of second light guide 125 and fourth edge 125d of adjacent second light guide 125 and FIG. 17 depicts a close-up side view of one embodiment of hybrid lighting system 100 showing gap 150 between second edge 125b of second light guide 125b and first edge 125a of adjacent second light guide 125.

As shown in FIGS. 16 and 17, second light guides 125 may be separated by gaps 150. Similar gaps can occur whenever panels are adjacent to each other. If gap 150 between first edge 125a of a first panel 105 and second edge 125b of a second panel is too large, an area of low light may appear on system 100. By keeping gap 150 small, the exitance from a first hybrid panel 105 may overlap the exitance from an adjacent hybrid panel 105 such that the intensity is nearly constant across gaps 150. To further decrease the likelihood of dead spots, second light guide 125 may be shaped, provided with phosphor layer 119 or roughened to create a diffuser, or otherwise configured to improve light distribution across gaps 150.

FIG. 17 further illustrates the situation in which one edge of hybrid lighting panel 105 includes first light guide 120 in which second light guide 125 does not overhang first light guide 120. In some embodiments, panel 105 may include filter 126 to improve light distribution across gap 150 between first light guide 120 and second light guide 125. According to one embodiment, filter 126 can be a neutral density filter allowing a select amount of light to escape from light guide 120.

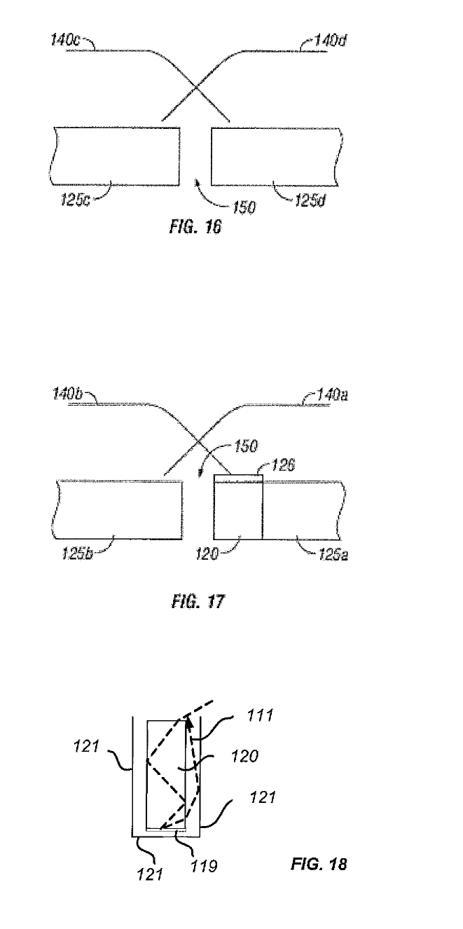

FIG. 18 illustrates a cross section of lighting system 100 with light guide 120 and reflector 121 showing an air gap between light guide 120 and reflector 121. The air gap allows light to TIR at the surface of light guide 120. Light that escapes (i.e., because it is at an angle of incidence so that it does not internally reflect) can be reflected by reflectors 121 (as depicted by dashed line 111). In one embodiment, lighting system can be configured so that only scattered pump blue light or down-converted light will strike reflector 121. By way of example, but not limitation, the reflector can be Teflon, Teflon paper, diffuse reflective plastic, silver coated plastic, white paper, TiO₂ coated material or other reflective material. In yet other embodiments, the reflector may not make any contact with first light guide 120 or be attached with adhesive or other material to the surface of first light guide 120.

While not all of the light will make it out light guide 120 on the first pass, upon subsequent passes and scattering, the integrated system will allow the majority of the energy to escape.

While reflectors 121 are shown on the three sides of light guide 120, reflectors 121 may be on one or two sides of light guide 120. In other embodiments, reflector 121 may also be disposed to reflect light from the end of light guide 120 opposite of the light source 115. If light guide 120 is shaped for angular control, an orthogonally separable diffuser can be used to divert blue light toward phosphor layer 119.

A hybrid lighting system 200 may be useful in any number of applications, such as backlighting for an LCD screens. By dividing the LCD into multiple panels 105, smaller LEDs using less power may be used to backlight the LCD and provide local dimming. Furthermore, using LED arrays that require less power can reduce the total power required to backlight the LCD. For mobile devices, such as laptops, the total power needed to backlight the LCD screen may be reduced to provide longer battery life without sacrificing lighting or contrast.

Advantages to the system may include the ability to provide local dimming for improved contrast, as well as lower power usage. Also, manufacturing panels that require a lower number of components may reduce the cost to manufacture. Manufacturing an array of small panels may enable large systems to be assembled with less cost than manufacturing a single large panel.

In the foregoing specification, the disclosure has been described with reference to specific embodiments. However, as one skilled in the art can appreciate, embodiments of the panels and light guides disclosed herein can be modified or otherwise implemented in many ways without departing from the spirit and scope of the disclosure. Accordingly, this description is to be construed as illustrative only and is for the purpose of teaching those skilled in the art the manner of making and using embodiments. It is to be understood that the forms of the disclosure herein shown and described are to be taken as exemplary embodiments. Equivalent elements or materials may be substituted for those illustrated and described herein. Moreover, certain features of the disclosure may be utilized independently of the use of other features, all as would be apparent to one skilled in the art after having the benefit of this description of the disclosure.

What is claimed is:

1. A hybrid lighting panel comprising:
a first light guide for receiving light, wherein the first light guide is configured to distribute the light out of a first light guide exit face along a length of the first light guide; and
a second light guide having an entrance face configured so that light exiting the first light guide face enters the second light guide, wherein the second light guide is configured to distribute light across the width of the second light guide so that light exits from a second light guide exit face.

2. The hybrid lighting panel of claim 1, wherein the first light guide has a taper, wherein the taper is configured to increase the uniformity of distribution of light out the first light guide exit face.

3. The hybrid lighting panel of claim 1, further comprising a light source, wherein light emitted by the light source enters into an entrance face of the first light guide.

4. The hybrid lighting panel of claim 3, wherein the light source comprises an LED array.

5. The hybrid lighting panel of claim 4, wherein the LEDs in the LED array comprise red, green and blue LEDs.

6. The hybrid lighting panel of claim 4, comprising a phosphor layer disposed on a face of the first light guide opposite the first light guide exit face and orthogonal to the entrance face of the first light guide.

7. The hybrid lighting panel of claim 6, wherein the phosphor layer comprises spatially separated phosphors.

8. The hybrid lighting panel of claim 5, further comprising a phosphor layer disposed on a face of the second light guide.

9. The hybrid lighting panel of claim 4, comprising a second LED array, wherein the first LED array is located at a first end of the first light guide and a second LED array is located at a second end of the first light guide.

10. The hybrid lighting panel of claim 3, further comprising one or more fiber optic cables for transmitting light from the light source to one or more light guides including the first light guide.

11. A hybrid lighting panel system, comprising:
a plurality of hybrid lighting panels, wherein each hybrid lighting panel comprises:
a light source;
a first light guide having a first end, wherein light emitted by the light source enters a first light guide entrance face at the first end of the first light guide, wherein the first light guide is configured to distribute the light along the length of the first light guide and out a first light guide exit face; and
a second light guide having a second light guide entrance face in contact with the first light guide exit face, wherein the second light guide is configured to distribute the light entering from the first light guide exit face across the second light guide and out a second light guide exit face; and
wherein the plurality of hybrid lighting panels are proximate each other, wherein each of the hybrid lighting panels is configured so that of light exiting the second light guide will overlap light from an adjacent panel.

12. The system of claim 11, wherein the light source comprises an LED array.

13. The system of claim 12, wherein the LEDs in the LED array comprise red, green and blue LEDs.

14. The system of claim 12, further comprising a phosphor layer disposed on a face of the first light guide opposite the exit face of the first light guide and orthogonal to the entrance face of the first light guide.

15. The system of claim 14, wherein the phosphor layer comprises spatially separated phosphors.

16. The system of claim 13, further comprising a phosphor layer disposed on a face of the second light guide opposite the second light guide exit face.

17. The system of claim 12, wherein a portion of the LED array is located at a first end of the first light guide and a portion of the LED array is located at a second end of the first light guide.

18. The system of claim 11, further comprising one or more fiber optic cables for transmitting light from the light source to one or more light guides including the first light guide.

19. An LCD (liquid crystal display) panel comprising:
an LCD layer;
a plurality of hybrid lighting panels, wherein each hybrid lighting panel comprises:
a light source;
a first light guide having a first end, wherein the first light guide is configured to distribute the light entering the light guide at the first end from the light source along the length of the first light guide and out a first light guide exit face; and
a second light guide having an entrance face in contact with the first light guide exit face, wherein the second light guide is configured to distribute the light entering from the first light guide exit face across the second light guide and out a second light guide exit face, wherein the second light guide exit face is parallel to the LCD layer.

20. The LCD panel of claim 19, wherein the first light guide is shaped so that light from the first light guide exit face projects on a plane perpendicular to the LCD layer.
